(19) United States
(12) Patent Application Publication
(10) Pub. No.: US 2005/0060534 A1
(43) Pub. Date: Mar. 17, 2005

(54) Using a random host to tunnel to a remote application

(76) Inventor: Mazda A. Marvasti, Rancho Santa Margarita, CA (US)

Correspondence Address: MCCERMOTT, WILL & EMERY;Suite 3400, 2049 Century Park East, Los Angeles, CA, 90067, US

(21) Appl. No.: 10/664,061

(22) Filed: Sep. 15, 2003

(51) Int. Cl. H04L 9/00

(52) U.S. Cl. 713/151

(57) ABSTRACT

A method for establishing communications between monitoring software located on a monitoring server is disclosed. A remote server includes an SSH server application and a remote application to be accessed by the monitoring software. The address information for the remote server is obtained. A secure tunnel is established between the remote server and the monitoring server. The monitoring software generates a random host and port, which is mapped to the remote host and port such that all communications between the two servers are encrypted by the tunnel. In one embodiment, the monitoring software includes Java software adhering to the JDBC protocol for making queries to the remote application, which is a JDBC database application.

### BACKGROUND

1. Field

The present invention relates generally to communications, and more specifically to securely accessing a remote application.

2. Background

Many protocols exist to enable communication between two applications over a network. Examples of such protocols used in conventional computer networks include rlogin, telnet, ODBC, JDBC, and ftp, among others. While providing a variety of useful services, these protocols generally do not use any type of encryption technique to secure the transmitted data.

Various monitoring software tools may be used to monitor the status and availability of applications running on different servers. When checking for application availability, often it is necessary for a client device to use insecure means of establishing a connection to a server. For instance, Java-based applications may be used to monitor a database application resident on a remote server. The Java-based application may access the database through Java Database Connectivity (“JDBC”). JDBC is a standard that provides a flexible and robust vehicle for Java-based applications to seamlessly access and interface with a database. Because JDBC connections can be insecure, the transmitted data (including a username and password) is subject to interception by an unscrupulous intruder. If the database application lies outside of the user's network on a remote server, the potential for security breaches can become a significant factor.

To reduce the possibility of security breaches of the database application at the remote server end, the network administrator for the remote server may block external access to the TCP database port by a firewall. The application on the monitoring server may be prevented from accessing the remote application altogether.

Accordingly, a need exists to provide a mechanism for accessing, by an application on a local server, an application on a remote server which is secure and which does not compromise the ability of the remote network administrator to block ports associated with the remote server via a firewall.

### SUMMARY

In one aspect of the present invention, a method for establishing a secure communications path between a first application on a first server and a second application on a second server includes obtaining host and port addresses of the second server, establishing a secure tunnel from the first server to the second server, generating random local host and port addresses at the first server, mapping the random local host and port addresses to the host and port addresses of the second server, and connecting the first application to the random local host and port addresses.

In another aspect of the present invention, a method for communicating between a first application on a local server and a second application on a remote server includes establishing a secure tunnel between the local server and the remote server, mapping a random host and an associated random port on the local server to a secure host and port on the remote server, transmitting a connection request from the first application on the local server to the random host, forwarding the connection request from the random port of the random host over the secure tunnel to the secure host on the remote server, transmitting the connection request from the secure host to the second application, and communicating between the local and remote applications.

In still another aspect of the invention, a local server configured to establish communications with a remote server over a secure tunnel includes a first application, a randomly generated host coupled to the first application, the randomly generated host further including a randomly generated port configured to be coupled to the secure tunnel and to the remote server.

Other embodiments of the present invention will become readily apparent to those skilled in the art from the following detailed description, wherein it is shown and described only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is an illustration of an exemplary tunneling technique using a Secure Shell (“SSH”) protocol.

FIG. 2 is a drawing of an exemplary monitoring server coupled to a plurality of remote servers in accordance with an embodiment of the present invention.

FIG. 3 is a diagram of a monitoring application on a monitoring server accessing a desired application on a remote server in accordance with an embodiment of the present invention.

FIG. 4 is a flow chart representation of an illustrative sequence of steps for accessing an application on a remote server in accordance with an embodiment of the present invention.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention. For the purposes of this disclosure, the terms “connected to” and “coupled to” can either connote a direct connection or, where appropriate in the context, can mean an indirect connection, e.g., through intervening or intermediary devices, network connections, applications or other means.

Numerous protocols exist for establishing communications between an application running on one server and another application running on a remote server. Such protocols include, for example, POP, SMTP, telnet, rlogin, ODBC, JDBC, etc. Certain of these protocols may be operating system specific. Others are proprietary; still others are based on open standards. Additional types of protocols exist for establishing communications between applications over other network types such as telephone, cellular, or radio networks.

“Monitoring” software tools are commonly used in various industries to oversee the operational status and availability of applications running on remote servers. These remote servers, for example, may be within a customer's network or general physical location, or in a geographically different location from the “monitoring” server upon which the monitoring software tools (also referred to collectively as the “monitoring application”) reside. In an illustration involving the Internet and a monitoring application resident on a monitoring server, the monitoring of the remote application may be performed in part using the TCP/IP protocol stack to transmit and receive data packets.

These monitoring software tools are commonly written in Java. Java has been described as a network-savvy, robust, object-oriented, dynamic, high-level programming language. Among plethora other attributes, Java maintains an extensive library of routines for seamlessly interfacing with TCP/IP protocols like HTTP and FTP. Further, Java has certain advantages over other high-level programming languages. Most existing programming languages are compiled directly into machine code specific to the platform upon which they are run. For each platform, these languages need to be recompiled. Java, however, is ordinarily compiled into an intermediate representation called Java Byte Code. The Java Byte Code is then interpreted by a machine-specific interpreter called a Java Virtual Machine (“JVM”). Thus, provided that the monitoring server and remote server each include a JVM, Java applications are portable from network to network regardless of platform, and no recompilation is necessary.

The Java language is completely specified and, by definition, must support a known core of libraries. One such library is Java Database Connectivity (“JDBC”). JDBC is an increasingly popular library for database interfaces. In recognition of JDBC's numerous capabilities, database vendors are continuing to develop bridges from the JDBC Application Programming Interface (“API”) to their particular database systems. Using Java in conjunction with the JDBC standard set provides a portable solution for writing database applications that can be efficiently monitored and queried by Java monitoring tools. For all of these reasons, it is not surprising that JDBC is a standard adopted by a majority of database vendors. The end result is that a growing body of portable software tools is being developed that enable the Java based software tools to seamlessly communicate with vendors' databases.

The growing popularity of the JDBC standard set and its increasing platform-independent applications is but one development that underscores the need for a more robust, flexible, and secure system for establishing communications between applications on different servers.

The majority of the protocols referenced above—JDBC included—do not employ any encryption technique when transmitting data from the monitoring software on the monitoring server to the remote server. For example, when a user logs onto a remote server using a telnet protocol, the username and password associated with the protocol are transmitted via clear text. The obvious problem is that an ill-intentioned individual or a malicious program can discern this information and hijack the session, thereby obtaining direct access to the end server.

Firewalls on Remote Servers

Network administrators often respond to the lack of security associated with these protocols by configuring their firewalls in a manner that may disrupt legitimate communication attempts between applications on different servers. For example, a network administrator responsible for a remote server on which a database application resides may simply configure the firewall to block external access altogether to the default database TCP port. Blocking this port reduces vulnerabilities in the remote server and increases security. Unfortunately, a problem is created by configuring the firewall on the remote server in this manner. Legitimate client applications attempting to access services on the network may no longer have access. In short, the present state of the art reflects a potential conflict between legitimate users of firewalled applications and the network administrators. Stated differently, the greater the security of remote applications, the less their accessibility.

Secure Shell (“SSH”) Protocol and Tunneling

Where the Internet is used to relay confidential data and heightened security is required, the prevailing view is that the data should be encrypted and the sender and receiver of the data should be authenticated. As noted, the foregoing problems often arise due to protocols that provide no mechanism for encryption, such as JDBC (or that provide an inadequate encryption mechanism in light of the present state of decryption knowledge).

Certain protocols employ various techniques to encrypt the session when establishing communications between an application on the monitoring server and an application on the remote server. One of the more popular protocols is Secure Shell (“SSH”), developed by SSH Communications Security Corporation. SSH typically uses the well-known TCP port of 22 to communicate with other devices; however, a variety of ports and encryption settings can be selected for use with SSH.

Secure Shell (“SSH”) is essentially a de-facto standard for remote logins and encrypted file transfers. Put simply, SSH is a secure method for logging onto a computer. SSH encrypts all communications between the client and server such that no third party can eavesdrop. SSH provides for the authentication and encryption of data transmitted over the Internet or other communications media. Due to its ability to provide secure transmissions, SSH is used widely in connection with remote logins and encrypted file transfers. SSH can also be used to provide a secure vehicle to enable communications between a variety of applications, allowing financial institutions, governmental organizations, and corporations to perform transactions securely over the Internet.

SSH secures connections over the Internet by encrypting all transmitted confidential data, including passwords, binary files, and administrative commands. SSH may also “tunnel” arbitrary TCP sessions by transmitting and receiving otherwise insecure TCP traffic over a single encrypted Secure Shell connection using the SSH protocol. Tunneling, or port forwarding, is a powerful feature that makes it possible to secure the communication of other applications and protocols without modifying the applications themselves. SSH enables the creation of an encrypted network tunnel between a local and remote computer. Insecure communications, such as FTP, POP, POP3, SMTP, HTTP, JDBC, and the like, can be routed securely through the tunnel. All data passing between the hosts through the tunnel in both directions, including passwords, are encrypted. A tunnel can be used in an insecure network or the Internet to provide secure communications between applications on different servers.

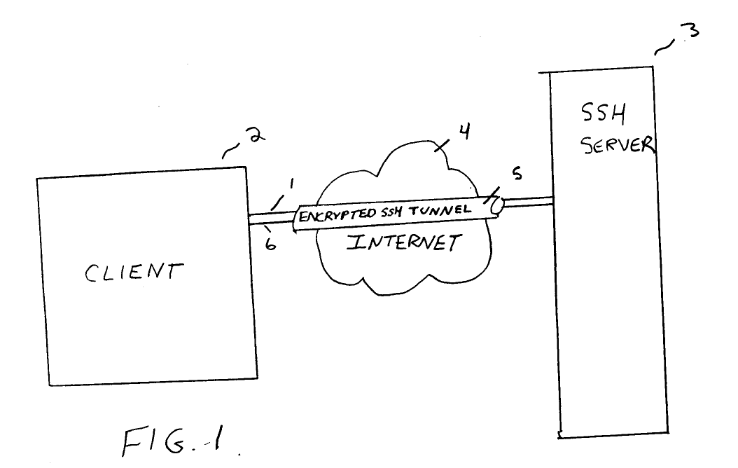

An example of tunneling is shown in FIG. 1. A terminal session illustrated by line 6 is initiated between a client 2 and an SSH server 3, establishing an encrypted SSH tunnel 5 through the Internet 4. Certain operations governed by the SSH protocol are performed to establish tunnel 5. For example, the appropriate port and host addresses of the client are mapped to the port and host associated with the SSH server. That mapping is recorded such that transmissions from the client application to the intended server application traverse the tunnel, and vice versa. Once the tunnel 5 is established, the client 3 may encrypt data using an SSH facility pursuant to the decided-upon encryption level. The client 2 may transmit the encrypted TCP traffic (line 1) through tunnel 5 to the SSH server 3. Likewise, the SSH server encrypts data to be sent over the tunnel 5, where it is decrypted by client 2. The properties of the connection and the specific actions required for creation of the tunnel are dictated by the SSH protocol.

After the SSH server decrypts the data, the server then may send it to the intended application server (not shown). The application server may be, for example, an ftp server or SMTP server. The SSH server may, but need not, reside on the same physical device as the application server.

In sum, using this tunneling technique, a client can secure POP3, SMTP, HTTP, JDBC, and other otherwise insecure transmissions through SSH tunnel 4 for secure transmissions across the Internet 4, or other network or insecure connection.

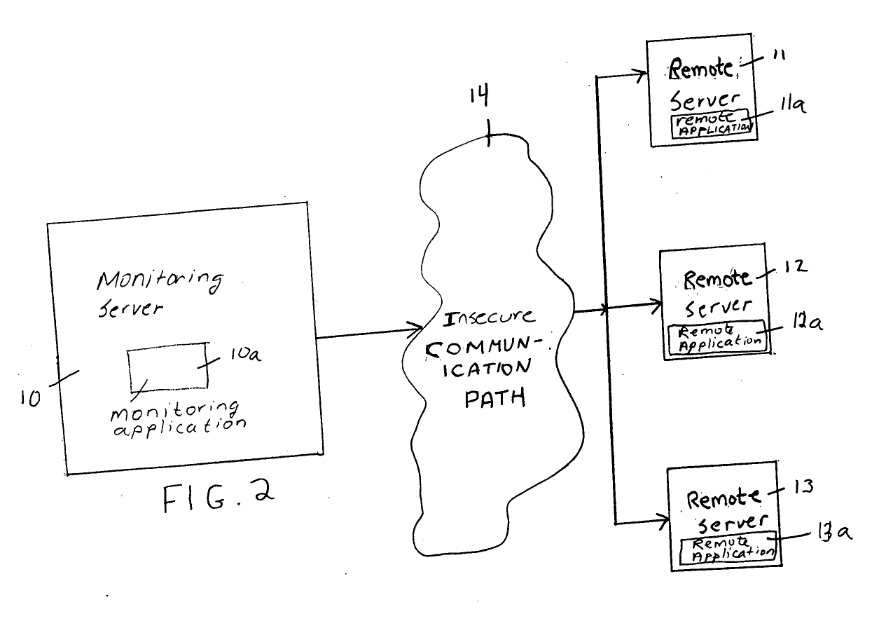

FIG. 2 shows an exemplary monitoring server 10 and three remote servers 11, 12 and 13 connected via insecure communication path 14. By assuming that data passing through this medium is non-encrypted and subject to unauthorized interception or modification, path 14 can be considered insecure. The communication path 14 can be the Internet, a Virtual Private Network (“VPN”), a network switch, a simple physical connection, etc.

On the monitoring server 10 resides a monitoring application 10a (or a set of such applications). While in the embodiment shown, the monitoring application 10a resides on the monitoring server 10, in certain other embodiments the monitoring application need not reside on the monitoring server 10 and may reside on a separate machine without departing from the scope of the present invention.

Also shown in FIG. 2 are three remote applications 11a, 12a, and 13a. In one embodiment these application constitute database applications to be accessed by monitoring application 10a. In certain embodiments these remote applications 11a, 12a, and 13a need not be on the same corresponding remote servers 11, 12, and 13, respectively. However, in order not to obscure the concepts of the present invention, the remote application is shown in this and ensuing Figures to reside directly on the remote server. Further, while in actuality monitoring application 10a or monitoring server 10 may also be considered clients rather than servers, because the monitoring server is configured to access services, for example, from remote application 11a. However, for consistency of nomenclature in this disclosure, the monitoring machine 10 will be designated as the monitoring server.

As FIG. 2 demonstrates, the network architecture can vary widely without departing from the scope of the invention. The remote servers 11, 12, and 13 may be considered “remote” from the monitoring server 10 only where an intervening insecure connection or network need be traversed.

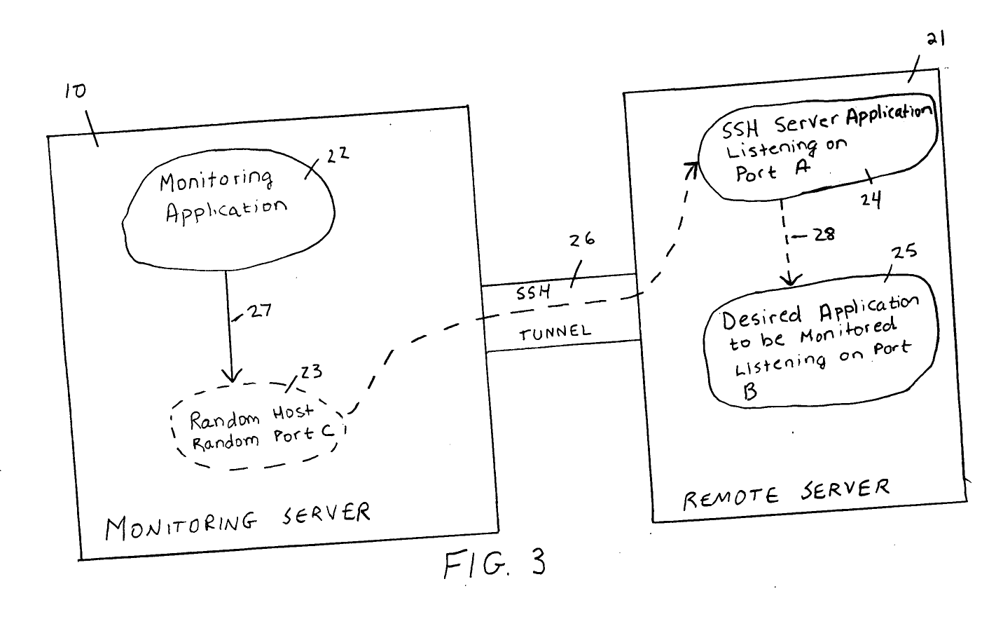

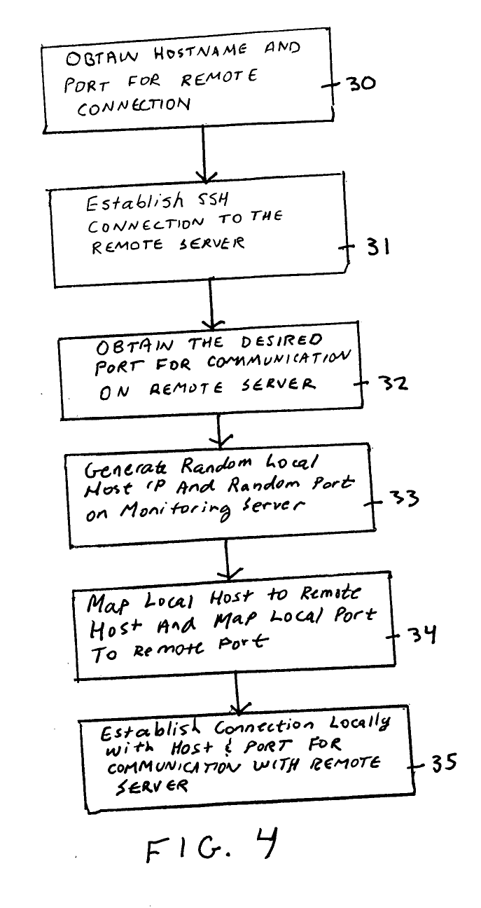

FIG. 3 is a diagram of a monitoring server and a remote server configured for establishing a communication link in accordance with an embodiment of the invention. A monitoring server 10 and a remote server 21 are shown. A monitoring application 22 resides on monitoring server 10. Also, a random host including a random Port C 23 resides on monitoring server 10. The random host is shown by circular dotted lines enclosed in a loop 23. The establishment of random host and port 23 is discussed in greater detail in connection with FIG. 4. On the monitoring server 10, the monitoring application 22 may transmit data to the random host and port 23.

The remote server 21 in FIG. 3 includes a desired application to be monitored, illustrated by closed loop 25. The desired application 25 is listening for data transmissions on Port B. Remote server 21 further includes an SSH server application 24, listening for data transmissions on Port A. SSH server application 24 includes a transmission path 28 to desired application 25 for forwarding data to the desired application 25.

Connecting the monitoring server 10 and remote server 21 is a secure SSH tunnel 26. One endpoint of the tunnel is the SSH server application 24. The other endpoint of the tunnel is the random host 23. As previously explained, the SSH tunnel 26 constitutes a secure tunnel within an insecure network (not shown). Data transmitted from random host 23 on the monitoring server 10 will be encrypted by an SSH encryption facility prior to being transmitted over SSH tunnel 26. Data transmitted from SSH server application 24 will likewise be encrypted prior to passage over tunnel 26, so that all data transmissions between monitoring server 10 and remote server 21 are secure. In one embodiment, multiple levels of encryption are used when sending data through SSH tunnel 26.

Ports A, B, and C will now be explained. Port A is a remote port associated with the SSH server application 24. Port A may use the conventional TCP port 22 commonly associated with SSH connections to external devices. However, other ports can also be selected. Transmissions from the random host 23 are received at port A of the SSH application server 24. Port B is a port of the desired application 25 associated with communications received from SSH server application 21. The communications to SSH server application 24, after being decrypted, are forwarded to desired application 25 via port B. Port B is not a port associated by convention for access by external applications directly to the desired application 25. Rather, port B is a port internal to remote server 21. Because port B is an internal port associated with transmitting and receiving data to and from the SSH server application 24, port B is not ordinarily subject to closure by a firewall.

The process to establish a secure communication link between monitoring application 22 and desired application 25 will now be described. The monitoring application 22 initiates a request to establish a connection to the desired application 25. This request is first routed via path 27 to the randomly selected port and host 23. Random host 23 acts as a routing mechanism for the connection request. The request is next encrypted and then routed via secure tunnel 26 to the SSH server application 24 on remote server 21. After decrypting the data, the SSH server application 24 forwards the connection request via link 28 and port B to the desired application 25. A connection is thereby established between monitoring application 22 on monitoring server 10 and desired application 25 on remote server 21. Secure communications may thereafter commence between the two applications.

In one embodiment, the desired application to be monitored 25 is a database application. The monitoring application 22 is written in the Java programming language, and the connection request constitutes a request to establish a JDBC connection to the database application. Because secure, programmatic communication to the database using JDBC is possible pursuant to the principles of the present invention, a requirement for agent-less database monitoring software is made possible.

From FIG. 3, the following observations can be made. First, a major security problem associated with many insecure applications (e.g., JDBC) is resolved. All communications between monitoring server 10 and remote server 21 are fully encrypted. Second, the security administrator of remote server 21 can block access via the corporate firewalls to the port(s) associated with the desired application 25 (e.g., a database port). The closure of these ports does not affect access by the monitoring application 22 to the desired application 25, because the call was routed through an internal secure SSH connection.

In certain embodiments, the remote server 21 may include a single computer or a plurality of devices connected as a secure network. Here, it is assumed for clarity that the remote server is a single machine. Likewise, the monitoring server 10 may include a single device or a network of secure devices. For instance, monitoring application 22 may embody a set or suite of applications distributed across one or more physical devices that collectively constitutes the monitoring server 10. In the embodiment shown in FIG. 3, the monitoring server 21 is assumed to be a single machine.

FIG. 4 is a flow chart showing an illustrative process of securing communications with a remote server in accordance with an embodiment of the present invention. As previously noted, the physical configuration of these applications may vary. Intervening applications or devices may also be present in some cases to implement configuration-specific details that remain within the scope and concepts of the present invention.

The process of this embodiment commences at step 30 of FIG. 4, where the monitoring application (such as the monitoring software tools previously discussed) obtains (whether through its own routines, or in conjunction with an operating system or through other intermediary applications or layers) a host name and a port identification for a target remote connection. This step involves, in one aspect involving a TCP/IP based network, obtaining the appropriate hostname of the remote server and the TCP port number (port A in FIG. 3) listening for SSH connections on that server. As an alternative to the hostname, the IP address may be obtained, whether directly from the remote server or through a DNS server, or other means. The default port number allocated to SSH at the time of this disclosure is 22. However, this number may be changed at the discretion of the administrator of the remote network. (In an alternative embodiment of another design or type of server application configured to establish a secure tunnel, the port number may also be unique to that application.)

In addition to the host name (or IP address) and port number of the remote server, a username and password for access to the SSH connection are either acquired or are known in advance. Once this information is known, the monitoring software next creates an SSH connection between the two servers, as in step 31. If the local server (on which the monitoring software resides) and the remote server each reside on a single machine, then the SSH connection will be established between these two machines. In one embodiment, the connection between the local server and remote server constitutes a secure SSH tunnel for sending encrypted communications.

In step 32, the monitoring software (whether independently or through intermediary software in conjunction with APIs and/or operating system) obtains the desired port (port B in FIG. 3) of the application for communication on the remote server. In one embodiment, it is assumed that a JDBC interface is implemented and the desired application is a database application. Ultimately, the monitoring server connects to this port for communicating with the database. The monitoring server, however, does not communicate with the database application directly (e.g., through the database application's dedicated TCP port). In one embodiment, the database port of the application is blocked by a firewall governing access to the remote server. The firewall, implemented by the administrator of the remote server, is configured to thwart security breaches by malicious code or unauthorized users.

Instead, as described in step 33, the monitoring tools (directly or indirectly) obtain a random local host and a random port on the monitoring server. The acquisition of this random host and associated random port may be through a variety of means, such as with an appropriately-configured random number generator, a dedicated software routine, or the like, and is a matter of design choice.

As an illustration, in an embodiment involving a typical IPv4 network in which an IP address is defined by four consecutive numbers separated by “periods” (e.g. 2.2.2.2), the IP range of addresses 127.0.0.1 to 127.255.255.255 may be reserved for use by the local host. (In other network environments using different protocols, a range of addresses may also be reserved for local use in a similar manner). Typically, 127.0.0.1 may refer to the network adaptor in place on the machine, such as an adapter ultimately used to connect to the remote host. On certain computers running Windows XP™, the IP address 127.0.0.2 is also used to identify a network adaptor. In this embodiment, then, a random local host in the range of 127.0.0.3 to 127.255.255.255 has 16,580,608 different possible addresses.

A random port may also be selected (port C in FIG. 3). In one embodiment, the random port may be chosen between 10,000 and 50,000, because values less than 10,000 are often used by other applications that may be concurrently running on the monitoring server. To avoid duplication of address assignments, an internal check may be performed in some embodiments to ensure that the selected random port is not being used (or otherwise reserved) for another application. While not necessary to the concepts of the present invention, an internal check in some instances may be a prudent way of avoiding duplicate address assignments.

The random port in the range described above would thus have 40,001 possible combinations. With the 40,001 possibilities for the chosen port, the combined number of possibilities—namely, the number of possible different values chosen collectively for the random local host and port—equals 663,240,900,608. As such, an intruder would first need to “guess” over 663 million possible combinations to be able to connect to the application running on the remote host. As this example illustrates, the “random” choice of local host and port in this aspect of the present invention adds considerable security to the system. This added security is a direct result of the step of choosing an arbitrary local host and port.

The choice of local host and port need not be “random” in the strict mathematical sense of that term (e.g., a program generating a pseudo random port number, or another configuration appropriate for the application is typically sufficient). “Random” in some embodiments may simply be that which is reasonably arbitrary under the circumstances to add an additional element of security to the system.

After generating the random local host IP address and random port, the monitoring server maps the local host to the remote host and the local port to the remote port (step 34). The information pertaining to the remote server was obtained in step 30. In one embodiment, this mapping is accomplished programmatically (i.e., via a computer program rather than interactively or manually). The program may instruct the SSH server application on the remote server to redirect all calls coming from the random local host and port to the desired remote host and port. Thus, any data traffic transmitted from the random port of the random local host flows over the secure tunnel. The step 34 of mapping the random host and remote host addresses and port addresses makes possible the secure tunnel 26 in FIG. 3.

In step 35, the monitoring software establishes a connection locally with the random host and port chosen in step 33. Thus, the remote application is now connected to the database application. All data from the random local host and port is encrypted by an SSH encryption facility. The monitoring software may freely communicate with the database application. These communications between the monitoring server and the remote server are encrypted and sent securely over the SSH tunnel.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for establishing a secure communications path between a first application on a first server and a second application on a second server, comprising:
obtaining host and port addresses of the second server;
establishing a secure tunnel from the first server to the second server;
generating random host and port addresses at the first server;
mapping the random host and port addresses to the host and port addresses of the second server; and
connecting the first application to the random local host and port addresses.

2. The method of claim 1 wherein the first application comprises database application monitoring software.

3. The method of claim 2 wherein the second application comprises a database application.

4. The method of claim 3 wherein the first application further comprises a Java Database Connectivity (JDBC) protocol configured to communicate with the database application.

5. The method of claim 1 wherein the first application comprises a Java program.

6. The method of claim 1 wherein the secure tunnel comprises a Secure Shell tunnel.

7. The method of claim 1 wherein the host and port addresses of the second server comprise Secure Shell server addresses.

8. The method of claim 1 wherein the obtaining the host and port addresses of the second server, establishing the secure tunnel, generating the random host and port addresses, and mapping the random host and port addresses are performed by a computer program.

9. The method of claim 8 wherein the computer program comprises the first application.

10. The method of claim 1 further comprising sending a connection request from the first application to the second application.

11. A method of communicating between a first application on a local server and a second application on a remote server, comprising:
establishing a secure tunnel between the local server and the remote server;
mapping a random host and random port on the local server to a secure host and port on the remote server;
transmitting a connection request from the first application on the local server to the random host;
forwarding the connection request from the random port of the random host over the secure tunnel to the secure host on the remote server;
transmitting the connection request from the secure host to the second application; and
communicating between the local and remote applications.

12. The method of claim 11 wherein the secure host comprises a Secure Shell server application.

13. The method of claim 12 wherein the secure tunnel is established using the Secure Shell server application.

14. The method of claim 11 wherein the establishing, mapping, transmitting and forwarding are performed programmatically.

15. The method of claim 11 wherein the establishing, mapping, transmitting, and forwarding are performed by the first application.

16. The method of claim 11 wherein the connection request comprises a JDBC connection request.

17. The method of claim 16 wherein the second application comprises a database application.

18. The method of claim 11 wherein the first application comprises the Java programming language.

19. The method of claim 11 wherein the first application comprises a monitoring application.

20. The method of claim 19 wherein the second application comprises a database application.

21. A local server configured to establish communications with a remote server over a secure tunnel, comprising:
a first application; and
a randomly generated host coupled to the first application, the randomly generated host comprising a randomly generated port configured to be coupled to the secure tunnel and to the remote server.

22. The local server of claim 21 wherein the first application is configured to access a second application on the remote server over the secure tunnel.

23. The local server of claim 21 wherein the first application comprises Java monitoring software.

24. The local server of claim 23 wherein the first application is configured to transmit a connection request via the randomly generated host and port to a second application on the remote server.

25. The local server of claim 24 wherein the connection request is a JDBC request.

26. The local server of claim 25 wherein the second application comprises a database application.

27. A local server configured to establish a secure communications session between a local application on the local server and a remote application on the remote server, comprising:
means for obtaining host and port addresses of the remote server;
means for establishing a secure tunnel between the local server and the remote server;
means for generating random host and port addresses at the local server;
means for mapping the random host and port addresses to the host and port addresses of the remote server; and
means for connecting the local application to the random host and port addresses.

28. Computer readable media embodying a program of instructions executable by a computer program to perform a method of establishing communications between a first application on a first server and a second application on a second server, the method comprising:
obtaining host and port addresses of the second server;
establishing a secure tunnel from the first server to the second server;
generating random host and port addresses at the first server;
mapping the random host and port addresses to the host and port addresses of the second server; and
connecting the first application to the random local host and port addresses.
